(19) United States
(12) Patent Application Publication
(10) Pub. No.: US 2016/0165894 A1
(43) Pub. Date: Jun. 16, 2016

(54) MICROBE-PROTECTIVE AGENT, PROCESSING AGENT OF PLANT PROTECTION AGAINST DISEASES AND COATED SEED TREATED THEREBY

(71) Applicant: TOKYO UNIVERSITY OF AGRICULTURE, Tokyo (JP)

(72) Inventors: Hirosuke SHINOHARA, Tokyo (JP); Hiromitsu NEGISHI, Tokyo (JP); Sayoko KASUYA, Tokyo (JP)

(73) Assignee: TOKYO UNIVERSITY OF AGRICULTURE, Tokyo (JP)

(21) Appl. No.: 15/053,016

(22) Filed: Feb. 25, 2016

Related U.S. Application Data
(63) Continuation-in-part of application No. PCT/JP2014/083705, filed on Dec. 19, 2014.

(30) Foreign Application Priority Data
Dec. 20, 2013 (JP) 2013-264217

(51) Int. Cl. A01N 59/00; A01N 63/00

(52) U.S. Cl. CPC A01N 59/00; A01N 63/00

(57) ABSTRACT

A microbe-protective agent comprises rock powder for suppressing the death of agricultural inoculants; and coated seeds obtained by coating plant seeds with said microbe-protective agent and an agricultural inoculants strain, The coated seeds are prepared by immersing seeds in an aqueous suspension containing an agricultural inoculant and a microbe-protective agent from rock powder. The microbe-protective agent protects agricultural inoculants against harmful microbes such as pathogens which cause plant disease.

### CROSS-REFERENCE TO RELATED APPLICATIONS

PCT/JP2014/083705 filed on Dec. 19, 2014, which claims priority to Japanese Patent Application No. 2013-264217 filed on Dec. 20, 2013. The entire disclosures of the above-mentioned applications are incorporated herein by reference.

### FIELD OF THE INVENTION

This invention relates to a microbe-protective agent, an agent for controlling diseases of plant, a processing agent for plant protection against diseases containing the microbe-protecting agent, a coated seed processed by the processing agent and the method for preparing thereof.

### BACKGROUND OF THE INVENTION

In modern agriculture, the pesticide technologies have been progressed to efficiently ensure food production, and the pesticide technologies are centered on chemical pesticides. Excessive use of chemical pesticides over many years causes such issues as the disturbance of the ecosystem, the food safety by pesticide residues, and the health hazard of farmers by the chemical pesticide use, and these issues have been illuminated. Therefore, in view of the safety and security, it has been sought to convert into the pesticides with low toxicity and little residues and to further reduce an amount of pesticides.

Along with this trend, the microbial control technology as one of the pesticide technologies has been receiving attention, which is suitable for conservation-oriented agriculture that takes into account environmental burden with the use of chemical pesticides. The “microbial control technologies” in this context refers to technology in general wherein “microorganisms that protect plant from pathogenic microorganisms” and “microorganisms that protect plants from pests” in natural habitat are applied to protect crops from insect pests and son on. The microbial control technology is expected to have less burden to crops, human beings and the environment and to greatly contribute to food safety and security.

As one of the microbial control technologies, conventionally, it is known to coat beneficial bacteria that are effective to control pests and pathogenic microorganisms on seed. However, the microbial control technologies have such problem that the efficacy decreases and loses over a period of time as the beneficial microorganism in the coated seed dies along with the passage of time.

Based on such backgrounds, published Japan patent application (Kokai) JP2011-201800A, which is referred to as patent document 1 hereinafter, describes a method for preventing the extinction of the beneficial microorganisms in the coated seed. The patent document 1 discloses a method for producing a coated seed includes the steps of placing a seed under vacuum conditions to remove ambient air or water and then inoculating the beneficial microorganism onto the seed under low pressure conditions so as to keep a stable number of beneficial microorganisms. The patent document 1 further discloses that, in producing a seed coated by beneficial microorganisms, examples of the microbe-protective agent for protecting beneficial microorganisms include a thickener, a stabilizer, polysaccharides, hydrophilic polymers, proteins, amino acids, salts of amino acids and so on.

Since, in patent document 1, the microbe-protective agent for suppressing the death of beneficial microorganisms in producing the coated seed is thickener, stabilizer, polysaccharides, hydrophilic polymers, proteins, amino acids, salts of amino acids and so on, which serves as nutrients for various microorganisms, it is likely that microbe-protective agent induces to multiply harmful microorganisms, which differs from the beneficial microorganisms, and which is illustrated by pathogenic fungi to cause plant diseases, and the concern remains the emergence of plant disease in the coated seed by the pathogenic fungi.

### BRIEF SUMMARY OF THE INVENTION

### Object of the Invention

One object of the present invention is to provide a microbe-protective agent in a powder form to suppress the death of a beneficial microorganism which protects plants from pests and other pathogenic microorganisms, and the beneficial microorganism does not serve as nutritional sources of the pathogenic microorganisms. Another object of the present invention is to provide a processing agent of plant protection against diseases containing the microbe-protective agent so that the death of the beneficial microorganism is stored over a long period, thereby suppressing the death of the bacteria during transportation and storage. Further object of the present invention is to provide a coated seed and a method for preparing the coated seed includes the step of coating a seed of plant by the processing agent of plant protection against diseases.

### Means for Attaining the Object

The present inventors contemplated the means to achieve the above-mentioned objectives and surprisingly find the results that coexistence of a rock powder, especially, a rock powder of certain types and sizes with a beneficial microorganism, suppresses the bacteria death, allows to keep the bacteria in the coated seed over a long term, and increases plant disease control effect in some cases. The present invention is based on the aforementioned finding and provides a microbe-protective agent containing a protective agent in a powder form for suppressing the death of the beneficial microorganism wherein the power is consisting essentially of a rock powder, thereby increasing the microbial control against plant diseases.

The present invention further provides a processing agent of plant protection against diseases containing at least one kind of beneficial microorganisms for increasing the microbial control against plant diseases and a microbe-protective agent consisting essentially of a rock powder for preventing the death of the bacteria cell; and a coated seed which is prepared from the step of coating a surface of a seed by the processing agent.

The present invention further provides a method of preparing a coated seed comprising the step of immersing a seed into an aqueous suspension comprising a microbe-protective agent consisting essentially of a rock powder and a beneficial microorganism.

### Advantageous Effects of the Invention

A microbe-protective agent of the present invention suppresses the death of the beneficial microorganism and which is an object of the protection, over a long period of time under normal conditions for storage and transportations. A microbe-protective agent of the present invention does not become a nutrient for microorganisms other than the beneficial microorganism, which the microbe-protective agent protects, for example, not a nutrient for harmful microorganisms, which may be a cause of plant diseases, it is advantageous that harmful microorganisms do not multiply. Therefore, when the processing agent of the plant seed including the microbe-protective agent and the beneficial microorganism is stored at a temperature ranging from 0 degree Celsius from about 40 degree Celsius, the beneficial microorganism keep alive for a longer period of time so that the effect of the microbial control in the plant is kept for a longer period of time.

In the coated seed in accordance with the present invention, both the beneficial microorganism and the microbe-protective agent are coated onto plant seeds so as to decrease a risk of proliferating pathogens, which are cause of plant diseases and to suppress the death of beneficial microorganisms during the transportation and/or storage. A process of preparing a coated seed in accordance with the present invention allows to efficiently produce the coated seeds with the aforementioned advantages. Apart or almost of the bacteria in the processing agent dies during the step of freeze-drying in a process for producing the processing agent. However, even the death of bacteria allows to keep the unusual effect of microbial control of the plant diseases.

### BRIEF DESCRIPTION OF THE SEVERAL VIEWS OF THE DRAWINGS

FIG. 1 shows a change of the number of living bacteria in a coated seed over a period of days. Towada-stone powder was used as a microbe-protective agent. The coated seed is prepared by the steps of immersing a seed into a liquid containing Towada-stone powder and Herbaspirillum sp. 022S4-11 strain, which is a preferable beneficial microorganism serving as a plant disease control, in a bacterial cell concentration of approximately 10⁸ cfu/ml and of decompressing the liquid mixture.

FIG. 2 shows a change of the number of living bacteria in a coated seed over a period of days. Oya-stone powder was used as a microbe-protective agent. The coated seed is prepared by the steps of immersing a seed into a liquid containing the powder and Herbaspirillum sp. 022S4-11 strain in a bacterial cell concentration of approximately 10¹¹ cfu/ml and of decompressing the liquid mixture.

FIG. 3 shows a change of the number of living bacteria in a coated seed over a period of days. Oya-stone powder was used as a microbe-protective agent. The coated seed is prepared by the steps of immersing a seed into a liquid containing the powder and Herbaspirillum sp. 022S4-11 strain in a bacterial cell concentration of approximately 10¹¹ cfu/ml.

FIG. 4 shows a change of the number of living bacteria in a coated seed over a period of days. Mica powder was used as a microbe-protective agent. The coated seed is prepared by the steps of immersing a seed into a liquid containing the mica powder and Herbaspirillum sp. 022S4-11 strain in a bacterial cell concentration of approximately 10¹¹ cfu/ml and of decompressing the liquid mixture.

FIG. 5 shows a change of the number of living bacteria in a powder which is subjected to the freeze drying over a period of days. The powder is prepared by the steps of mixing a suspension of bacterial cell of Herbaspirillum sp. 022S4-11 strain in a bacterial cell concentration of approximately 10⁹ with Towada-stone and water; freezing the mixture; and freeze-drying the mixture to obtain a powder containing the bacteria.

### DETAILED DESCRIPTION OF THE INVENTION

### 1. Microbe-Protective Agent

The microbe-protective agent in accordance with the embodiment of the present invention includes a protective agent in powder form to suppress the death of beneficial microorganisms, and the powder is characterized by a rock powder.

Type of the rock is not limited as long as the object and advantages of the present invention are achieved, and includes, for example, igneous rocks such as volcanic rocks, hypabyssal rock and plutonic rock; sedimentary rocks such as dastic rocks, pyroclastic rock (pyroclastic rocks), biological sediment rocks (life rocks), chemical precipitate rocks and evaporites; and metamorphic rocks such as contact metamorphic rocks, regional metamorphic rocks and power metamorphic rocks.

In view of suppressing the death of microorganisms, tuff, which is classified into the pyroclastic rocks or pyroclastics, and granite, which is classified into the plutonic rocks are preferable. Green tuff, pumice tuff and mica are further preferable among those rocks. Towada-stone, which is green tuff obtained in Akita prefecture in Japan, is especially preferable as the green tuff. Oya-stone, which is pumice tuff obtained in Tochigi prefecture in Japan is especially preferable as the pumice tuff. In addition to these stones, mica is also an effective rock powder.

As a process for preparing a rock powder, a conventional pulverizer grinds rocks into a rock powder.

The particle size of the rock powder is not limited as long as the object and advantages of the present invention are achieved. In view of the use as a coating agent for coating a plant seed, an average particle diameter preferably ranges from 1 to 400 micrometers, further preferably not more than 100 micrometers, and still further preferably not more than 80 micrometers. The average particle diameter refers to the integral value of 50% in a particle distribution obtained by laser diffraction and scattering. The rock powder may be one species or a mixture of at least two species.

### 2. Beneficial Microorganism

In view of the application of the microbial control of plant diseases, the microorganism to be protected in the present embodiment are selected to be a microorganism to give effective control over plant diseases, and such microorganisms are called “beneficial microorganisms” herein. The beneficial microorganism is not restricted as long as the beneficial microorganism is beneficial against plant diseases, and include, for example, plant growth promoting bacteria, rhizobia, mycorrhizal fungi, and microbes to inhibit plant pathogens by fungi parasitic effects, antibacterial, conflict, interference or antagonism, resistance induction and phagocytosis. Bacteria is preferred among these microorganism in view of storing microorganism for a long time. Gram-negative bacteria is more effective. Further, bacteria in the genus Herbaspirillum, bacteria in the genus Pantoea or bacteria in the genus Collimonas are especially effective. The microorganism to be stored in this context are different from microorganism to form durable organs such as spores of filamentous fungi and spores of some Gram-positive bacteria since the durable organ allows to keep a storage for a long period.

As the present inventors disclosed in Japan patent application No. 2011-211164, which corresponds to published Japan patent application (Kokai) JP2012-92093A, bacteria in the genus Herbaspirillum is effective to control bacterial diseases of the family Poaceae. Bacteria in the genus Herbaspirillum is at least one species selected from the group consisting of Herbaspirillum sp., Herbaspirillum rubrisubalbicans, Herbaspirillum autotrophicum, Herbaspirillum chlorophenolicum, Herbaspirillum frisingense, Herbaspirillum huttiense, Herbaspfrillum putei; Herbaspirillum seropedicae. Herbaspirillum sp. 022S4-11 strain is especially effective, and this strain is found by the present inventors and deposited at the International Patent Organism Depositary (IPOD) at Independent Administrative Institution National Institute of Technology and Evaluation (NITE) with the receipt number of FERM BP-22001.

The microbe-protective agent in accordance with the present embodiment suppresses the death of the beneficial microorganism, and the combination of the microbe-protective agent and the bacteria makes a processing agent of plant protection against diseases practical. The processing agent of plant protection against diseases is applied to a plant seed to coat thereon, and the processing agent is suitable for the preparation of the coated seed. The preparation thereof is mentioned hereinafter. In general, some of microorganisms tend to die during a long-term storage, the freezing process and the freeze and drying process, and therefore, to use microorganisms in controlling plant diseases has not been available so far. However, bacteria in the genus Herbaspirillum allows to keep alive at temperatures ranging from 0 degree Celsius to approximately 40 degree Celsius for a long period of time in the presence of the microbe-protective agent and beneficial microorganism, a processing agent of plant protection against diseases containing the bacteria is able to store and transport for a longer period of time compared to the conventional product. When a composition containing the beneficial microorganism and the microbe-protective agent in accordance with the present embodiment is freeze-dried, most of the bacteria exterminates. Surprisingly, the effect of plant disease control after the freeze-dry process is the same as before the freeze-drying process or even increases in some cases.

### 3. Processing Agent of Plant Protection Against Diseases

A processing agent of plant protection against diseases in accordance with the present embodiment is a composition containing a microbe-protective agent consisting essentially of the rock powder and the beneficial microorganism, such as bacteria cell in the beneficial microorganism. A preferable form of the processing agent is a liquid composition wherein the microbe-protective agent and the bacteria cell are suspended in water. The processing agent of plant protection against diseases in accordance with the present invention may be a composition in a powder form wherein the microbe-protective agent in the powder form is blended with the bacterial cell and another composition in a form of pellets wherein the composition in the powder form is formed into pellets. The processing agent of plant protection against diseases may be a composition in the form of particles, which is prepared by a process comprising the step of producing a suspension of the microbe-protective agent and the bacteria cell and freeze-drying to produce particles. The processing agent of plant protection against diseases may contain another component and materials which differ from the microbe-protective agent and the beneficial microorganism, as long as these processing agent of plant protection against diseases does not preclude the purpose and advantages of the present invention. The processing agent may be used preferably as a coating agent of the plant seed as mentioned later. However, the processing agent may be directly applied to the branch, leaf, stem, and roots, which include bulbs, of plants. Alternatively, the processing agent may be scattered in a field where plants are growing.

### 4. Coated Seed

Coated seed related to an embodiment of the present invention is a plant seed coated with a composition consisting essentially of the above microbe-protective agent and beneficial microorganism such as bacteria cells of the beneficial microorganism.

Seeds used in this embodiment may be any common plant seeds and include agricultural seeds, which further include, for example, seeds of the Poaceae family including rice, corn, wheat, barley; seeds of the genus Allium such as onions, leeks; seeds of Chenopodiaceae such as beets, spinach, and so on; seeds of Brassica including cabbage, Chinese cabbage, cauliflower, broccoli, radish, and so on; seeds of the bean family, including fava beans, peas and other legumes; seeds of Apiaceae such as carrot, celery, and Cryptotaenia canadensis; seeds of Asteraceae including lettuce, Glebionis coronaria, burdock; seeds of Solanaceae, tomatoes, eggplant, bell peppers and so on; seeds of Cucurbitaceae, such as melons, cucumbers, watermelon, pumpkin; seeds of Floriculture such as pansy, viola, petunia, lisianthus, stock, Astor, cyclamen, Primula, Snapdragon, Zinnia, Marigold, morning glory, sunflowers, Cosmos, Ranunculus, lavender, Lupine, erinus, poppy, Begonia, nemesis, vinca, torenia, delfinum, Dianthus, geranium, gomphrena globosa, sweet pea, Salvia, Gerbera, gazania, calendula, fotsch, celosia, impatiens, Anemone, and ageratum.

The coated seed is prepared by a process comprising the step of applying the microbe-protective agent consisting essentially of the rock powder onto at least a part of the surfaces of the plant seed and applying the beneficial microorganism onto at least the part of the surfaces of the plant seed wherein the two steps may be carried out at the same time or sequentially. Preferably, the whole surface of the coated seed is coated by the composition including microbe-protective agent consisting essentially of the rock powder and the bacteria cells.

A process of preparing the coated seed in accordance with the present embodiment may be, for example, (a) a process of immersing a seed in an aqueous suspension including the microbe-protective agent and beneficial microorganism such as the bacteria in the beneficial microorganism, which is referred to as the bacteria suspension hereinafter, for a period of 1 to 48 hours at a temperature ranging from about 15 degree Celsius to about 35 degree Celsius, (b) a process including the steps of immersing a seed in the bacteria suspension containing the microbe-protective agent and the bacteria cell; and stirring the bacteria suspension while immersing the seed; (c) a process including the steps of immersing a seed in the bacteria suspension containing the microbe-protective agent and bacteria cell at a temperature of about 15 degree Celsius to about 35 degree Celsius and depressurizing the bacteria suspension for a period of 30 minutes to 2 hours during the immersion; (d) a process including the step of spraying the bacteria suspension containing the microbe-protective agent and bacteria cell onto a seed or; (e) a process including the step of coating a seed onto a powder mixture containing the microbe-protective agent and the bacteria cell in a powder form. Among these process, the process of immersing the seed in the bacteria suspension containing the microbe-protective agent and bacteria cell and stirring the bacteria suspension at a temperature of ranging from 5 degree Celsius and about 40 degree Celsius is preferable since the process produces the coated seed efficiently.

The seed coated with a freeze-dried powder shows superior microbial control over bacterial disease in plant, especially, rice plants in seedling stage compared to the case that beneficial microorganism is applied without the microbe-protective agent.

The coating agent may be obtained by a process of mixing the microbe-protective agent with the beneficial microorganism in water, and freeze-drying the mixture in the conventional means to give a freeze-dried powder. The powder thus obtained may be used as a coating agent.

The coated seed in the present embodiment may contain the component and materials, which are different from the microbe-protective agent and the beneficial microorganism as long as the object and advantages of the present invention are maintained.

The coated seed in accordance with the present embodiment suppresses the death of beneficial microorganism, which are coated in the seed, during the storage and transportation in standard conditions, and therefore, the bacteria cells coated in the seed maintains its microbial control against the disease. In this case, preferably, temperatures range from 0 degree Celsius to 40 degree Celsius during the storage and transportation. The microbe-protective agent in the coated seed does not proliferate pathogens, which are cause of plant diseases, so as to decrease a risk of plant diseases resulting from the proliferation of the pathogens. Further, the coated seed in accordance with the coated seed allows to keep the beneficial microorganism alive for a longer period of time, the coated seed may be applied in a wide range of microbial control of plant diseases.

### 5. Process of Preparing a Coated Seed

A process of producing a coated seed in accordance with the preferred embodiment of the present invention includes the steps of preparing an aqueous suspension of the microbe-protecting agent and the beneficial microorganism and immersing a seed in the suspension

In the present embodiment, firstly, the aqueous suspension is prepared from the microbe-protective agent, the beneficial microorganism and water.

In this case, a small amount of water-soluble organic compounds such as carboxymethyl cellulose (CMC), polyvinyl alcohol (PVA), starch may be added into the aqueous suspension above. In the present embodiment, however, these water-soluble organic compounds are unnecessary since the suspension without the organic compounds allows to form a sufficient coating onto the seed.

A form of the suspension including the beneficial microorganism is not limited as long as the object and advantages of the present invention are achieved. The suspension may be a culture of the microorganism and an aqueous suspension prepared by centrifuging the culture, separating the bacteria cell from the supernatant, and then dispersing the bacteria cell in distilled water.

In case that the beneficial microorganism is a beneficial microorganism, the bacteria concentration in the aqueous suspension containing the microbe-protective agent ranges from 10⁷ to 10¹² cfu/mL in terms of the effect of microbial control of plant diseases.

Next, seeds are immersed in the aqueous suspension containing the above-mentioned microbe-protective agent at a temperature ranging from about 15 degree Celsius to 35 degree Celsius in 1-48 hours. This step allows to coat a mixture of the microbe-protective agent and the beneficial microorganism.

The seeds may be common plant seeds, and the aforementioned seeds of various plant seeds may be used.

A coated seed may be prepared by immersing seeds in the aqueous suspension containing the microbe-protective agent and the beneficial microorganism and depressurizing the aqueous suspension for 30 minutes to 2 hours during or after the immersing step. The decompression treatment improves retention rates of the microbe-protective agent and the bacteria to the seeds although, in the present invention, the decompression step is not essential.

These steps enable to produce a coated seed, which has no risk of proliferating microorganisms other than microorganisms to be protected, for example, pathogens of plant diseases, and which suppresses the death of beneficial microorganism during the storage.

When the freeze-dry powder is used as the coating agent of the seed, an aqueous suspension containing the beneficial microorganism, such as a bacteria cell of Herbaspirillum genus, and the microbe-protecting agent. A concentration of beneficial microorganism in the aqueous suspension is preferably at least 10⁶ cfu/ml, further preferably at least 10⁷ cfu/ml, and still further preferably at least 10⁸ cfu/ml. Also a concentration of the microbe-protective agent in the aqueous suspension preferably ranges from 10 to 60% by weight, more preferably from 20 to 50% by weight, and further preferably 30 to 40% by weight.

The aqueous suspension prepared in this way is treated by a typical freeze drying equipment to freeze dry thereof to produce the desired seed coating agent. In implementing the freeze drying process, firstly, a preliminary freezing is carried out, and then it is freeze dried under a reduced pressure to give the freeze dried.

Means to coating a seed with the coating agent is not limited. But to ensure adhering coatings on seed, a process including the steps of adding the coating agent of the seed in a powder from, which is obtained by freeze drying, into water to form a suspension; preparing a coating solution containing 3 to 35 weight percent of solid matters based on all the solid components excluding water; immersing seed in the coating solution; taking out from the coating solution; and drying the seeds naturally or by heating.

As another methods for coating seeds with the coating agents, seeds may be added to the coating agent in a powder form, and the mixture is stirred so that the coating agent is adhered onto surfaces of the seed.

### Examples

### 1. Study on the Effects of Microbe-Protective Agent

### (1) Sample Seed

As sample seeds, rice seed of Koshihikari as used. The sample seeds were subject to a salt water with specific gravity 1.13, and then chosen. Next, the chosen seeds were treated with hot water at 60 degree Celsius for 10 minutes for the purpose of sterilization. The seeds after the salt water treatment and the hot water treatment were used as a sample seed.

### (2) Sample Rock Powder

A rock powder, which becomes a constituent of the microbe-coating agent for coating onto seeds, is prepared by passing Towada-stone, which is one of the green tuffs, through a 16-mesh sieve. The rock powder has a particle diameter between 1 to 80 micrometers and a particle distribution with a peak of 5 micrometers. Alternatively, the rock powder may be prepared by forming stone debris with the particle diameter of 1-80 micrometers from Oya-stone, which is one of the green tuffs, during processing stones in the stone processing plant and passing the stone debris through the 16-mesh sieve. Alternatively, the rock powder may be prepared by passing mica stone with the particle diameter of 1-80 micrometers, which was bought at an art supply shop through the 16-mesh sieve. The rock powder was sterilized at a temperature of 121 degree Celsius for a period of 20 minutes followed by adding the rock powder into an aqueous suspension of the bacteria cell described hereinafter.

### (3) Sample Bacteria Cell

Herbaspirillum sp. 022S4-11 strain was used as bacteria to coat onto seeds.

### (4) Preparation of Suspension of Bacterial Cells

In accordance with standard procedures, Herbaspirillum sp. 022S4-11 strain was inoculated onto a PPG liquid medium including 5 g of Bacto-Pepton, 5 g of glucose, 3 g of Na₂HPO₄12H₂O, 0.5 g of KH₂PO₄, 3 g of NaCl, and a 1000 ml soup prepared from 200 g of potatoes, and then the culture was cultivated while shaking for 2 days at 25 degree Celsius with a rate of 160 rpm. The culture was centrifuged at 8000 rpm for 7 minutes to separate bacterial cells from the culture supernatant, and the supernatant was removed to recover the bacteria cells. Into the recovered bacteria cells were added sterile water, an amount of which was equal to the amount of the supernatant removed so as to prepare two suspensions with differing concentrations of the bacteria cells. The cell concentrations in the two bacteria suspensions were about 10⁸ cfu/ml and about 10¹¹ cfu/ml, respectively.

### (5) Preparation of Coated Seed

A sample seed (2.8 g) was immersed for 24 hours in an aqueous water suspension (100 ml) containing 10 percent weight by volume of sample rock powder, and then the sample seed way dried by air so as to prepare a coated seed. While the seed was immersed in the bacterial suspension, the aqueous suspension was decompressed in a closed vessel by a water aspirator and a vacuum-pressure machine for an hour and then air-dried the seed so as to prepare the coated seed. In addition, the coated seed thus prepared was kept in a refrigerator at 4 degree Celsius, and a viable cell count in the coated seed was counted every day.

### (6) Measurement of the Viable Cell Counting in the Coated Seed

Measurement of coated seed in viable cell count went through in the following way. Namely, the coated seed was added into a mortar, 1 mL of sterile water for each coated seed was added, and the coated seed was ground by a pestle to prepare a ground liquid. The ground liquid was diluted in stepwise (10 times, 100 times and 1000 times diluted), and then 100 microlitter of diluted liquid was applied to a standard agar so as to incubate 5 days at 25 degree Celsius. After the incubation, the number of emergent colonies was counted to as to calculate a viable cell count in the coated seeds.

### (7) Results

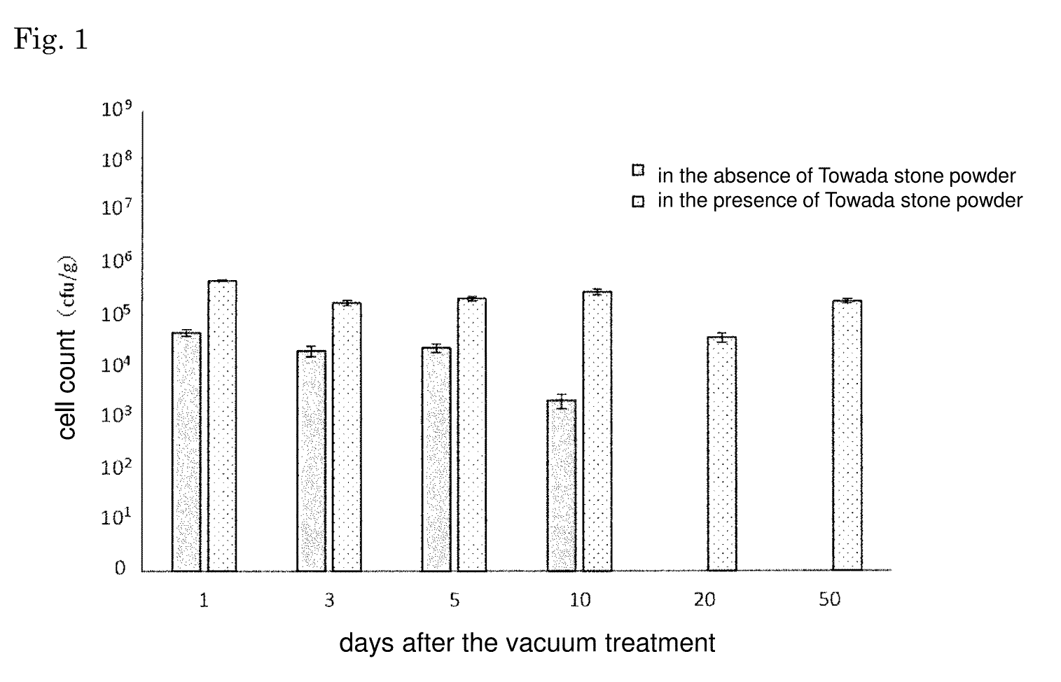

FIG. 1 shows a change of the cell count in the coated seed over a period of days in the working example and the control. In the working example, Towada-stone powder was used as a microbe-protective agent. The coated seed was prepared by the steps of immersing a seed into a suspension containing Towada-stone powder and Herbaspirillum sp. 022S4-11 strain in a bacterial cell concentration of approximately 10⁸ cfu/ml and decompressing the suspension during the immersion step. The working example contained the microbe-protective agent whereas the control did not contain the microbe-protective agent. As shown in FIG. 1, in the coated seed coated with the Towada-stone powder and the Herbaspirillum sp. 022S4-11 strain, a cell count of the Herbaspirillum sp. 022S4-11 strain in the coat was 10⁵ cfu/g in one seed at the first day. When this seed was kept at room temperature, a cell count of the living bacteria remained 10⁵ cfu/g after a period of fifty days from the date of the preparation. The use of the microbe-protective agent allows a surviving rate of 100 percent, which is quite high, after a period of the fifty days from the preparation.

In contrast, when the Herbaspirillum sp. 022S4-11 strain was coated without the use of the microbe-protective agent, a cell count of Herbaspirillum sp. 022S4-11 strain was 10⁴ cfu/g per seed at the first day of the preparation, no living bacteria Herbaspirillum sp. 022S4-11 strain was observed after a period of twenty days from the day of the preparation, and no living bacteria of Herbaspirillum sp. 022S4-11 strain was observed after a period of fifty days from the day of the preparation wherein the result of the fifties day was evident beforehand.

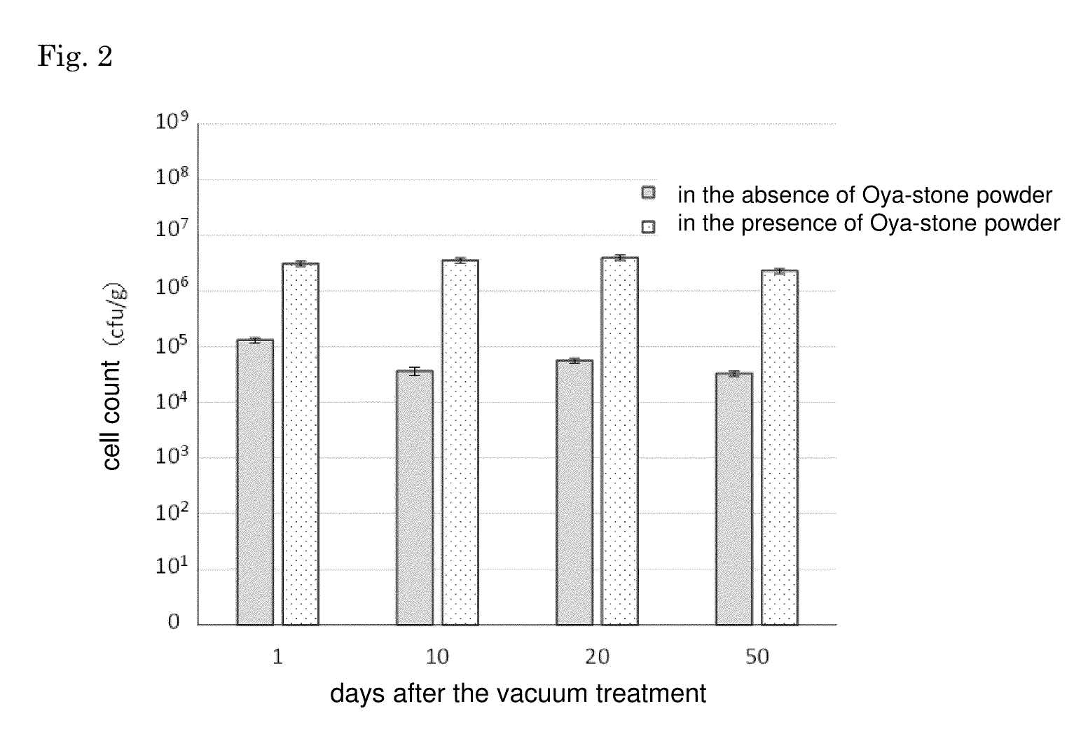

FIG. 2 shows a change of the cell count in the coated seed over a period of days in the working example and the control. In the working example, Oya-stone powder was used as a microbe-protective agent. The coated seed was prepared by the steps of immersing a seed in a suspension containing the Oya-stone powder and Herbaspirillum sp. 022S4-11 strain in a bacterial cell concentration of approximately 10¹¹ cfu/ml and decompressing the suspension during the immersion step. The working example contained the microbe-protective agent whereas the control did not contain the microbe-protective agent. As shown in FIG. 2, in the coated seed coated with the Oya-stone powder and the Herbaspirillum sp. 022S4-11 strain, a cell count of the Herbaspirillum sp. 022S4-11 strain in the coat remained the same even after a period of fifty days from the date of the preparation. Compared to the control wherein only the Herbaspirillum sp. 022S4-11 strain was coated, a larger number of bacteria remained alive.

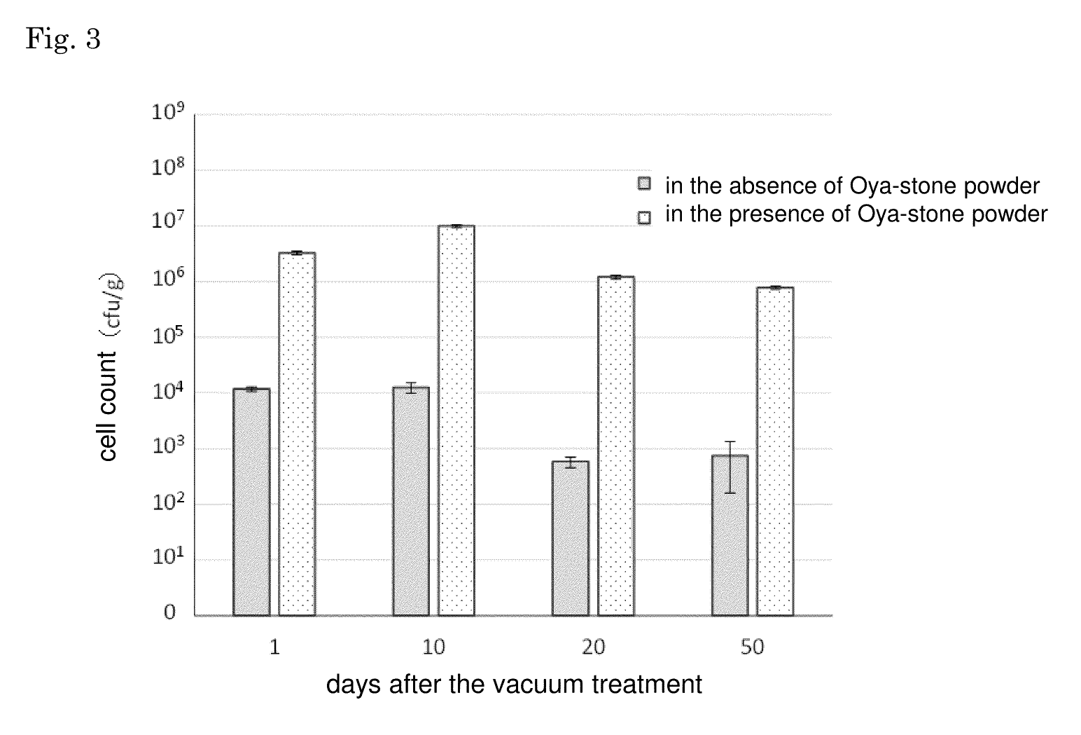

FIG. 3 shows a change of the cell count in the coated seed over a period of days in the working example and the control. In the working example, Oya-stone powder was used as a microbe-protective agent. The coated seed was prepared by the step of immersing a seed in an aqueous suspension containing Oya-stone powder and Herbaspirillum sp. 022S4-11 strain in a bacterial cell concentration of approximately 10¹¹ cfu/ml. The working example contained the microbe-protective agent whereas the control did not contain the microbe-protective agent. As shown in FIG. 3, the coated seed prepared by the step of immersing a seed in a suspension containing Oya-stone powder and Herbaspirillum sp. 022S4-11 strain without the decompression step maintains the living cell count, which is comparable to the coated seed prepared by the step including the decompression step as shown in FIG. 2. Therefore, we have found that the object of the present invention is achieved without the use of the decompression step.

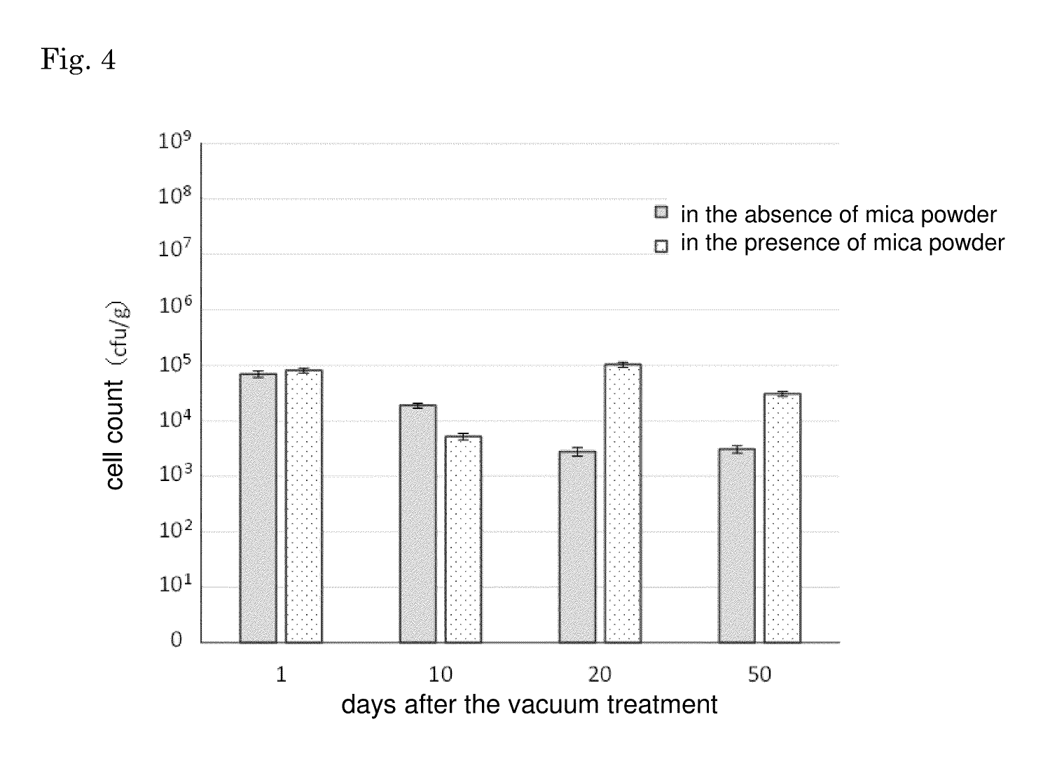

FIG. 4 shows a change of the cell count in the coated seed over a period of days in the working example and the control. In the working example, mica powder was used as a microbe-protective agent. The coated seed was prepared by the step of immersing a seed in a suspension containing mica powder and Herbaspirillum sp. 022S4-11 strain in a bacterial cell concentration of approximately 10¹¹ cfu/ml, and decompressing the suspension during immersing. The working example contained the microbe-protective agent whereas the control did not contain the microbe-protective agent. After a period of 50 days, a larger viable count was observed in the coated seed containing the Herbaspirillum sp. 022S4-11 strain and the mica powder serving as the microbe-protective agent, compared with the coated seed containing the Herbaspirillum sp. 022S4-11 strain without the microbe-protective agent.

In view of the foregoing, the aforementioned experiments confirmed that seed coating containing the bacteria cell in the genus Herbaspirillum and a microbe-protective agent, consisting essentially of Towada-stone powder, Oya-stone powder or mica powder enable to keep the bacteria cell in the genus Herbaspirillum for a prolonged period of time in the coated seed.

### 2. Study the Effects on Freeze-Dry Treatment

### (1) Preparation of the Coating Agent

As a sample microbe strain, the Herbaspirillum sp. 022S4-11 strain (contract number FERM BP-22001) used. Also, as a green tuff powder acting as a microbe-protective agent, Towada-stone powder having a particle size ranging from 1 to 80 micrometers and a peak at 5 micrometers in the particle size distribution, which is a commercial name “D. M. POWDER” ™ from Towada green Tuff and agro-science Co., Ltd., was used.

An aqueous suspension containing a concentration of Herbaspirillum sp. 022S4-11 10¹¹ cfu/ml and a concentration of 33 percent by weight of green tuff powder is prepared, the aqueous suspension was freeze dried at temperatures below −20 degree Celsius for 24 hours, and drying the freeze-dried in vacuum so as to prepare a coating agent in the form of the freeze dried powder consisting essentially of the bacteria cell and the green tuff (coating agent 1).

As a comparative example, Herbaspirillum sp. 022S4-11 strains were cultivated in a PPG medium while shaking the liquid culture at 25 degree Celsius for two days with 100 rpm to obtain a liquid culture, and the liquid culture of Herbaspirillum sp. 022S4-11 strain was freeze dried without the green tuff powder to prepare a coating agent (coating agent 2), which consists essentially of freeze-dried bacterial cells.

### (2) Preparation of Coated Seed

Seeds of rice (Koshihikari) was immersed in a suspension of pathogens of glume blight (Burkholderia glumae MAFF301441) (about 10⁸ cfu/ml), and the rice seeds were evacuated in vacuum for about 10 minutes to inoculate the rice seeds with pathogens. Then water was removed from the rice seeds, and rice seeds were spread over a surface of the laboratory towel and air dried at room temperature overnight so as to prepare rice seeds of a contamination rate of 10 percent.

Water was changed in the last time, and the seed was immersed in up to 32 degree Celsius in 16 hours so as to germinate and seeding seedlings. The seeds were planted and cultivated in a period of two weeks in treatment sections 1 and 2, respectively. The research on plant diseases was carried out thereafter. In addition, the research on plant disease was carried out in control in another treatment section wherein the immersion step was carried out without the coating agent, and germination was carried out and planted thereafter.

### (3) Seedlings

Seedlings of rice was carried out in each segment. With regard to seeding, to a plastic case having a depth of 35 mm, a length of 110 mm and a width of 110 mm, which has a bottom perforated with five through holes having a diameter of 1 mm for drainage was added clay for seedling from Iseki Baido, processed seeds (15 gram) was uniformly sown, and the seeds were covered with soil. After sowing, the plastic case was placed in a greenhouse made of glass and managed therein.

### (4) Disease Study

All seedlings in each segment were investigated on the degree of diseases, and the severity of the diseases are classified into three indexes, 0, 3 and 5 as follows.

dead seedling: index 5,

non-dead disease seedlings (anomalies such as whitening, dwarf, extraction):

index 3

healthy seedlings: index 0.

The disease rate was calculated in the following equation (1). Based on the disease rate, the suppressive effect was calculated in the following equation (2).

disease rate={Σ(number of incidence index)/(5×survey number)}×100 (1)

suppressive effect=(1−the disease rate in the treated segment/the disease rate in the non-treated segment)×100 (2)

### (5) Results

Table 1 shows the suppressive effect on glume blight of rice in each segment. Results in Table 1 are average values of tests repeated three times. In one segment where coating agent 1, which is the freeze-dry powder consisting essentially of the Herbaspirillum sp. 022S4-11 strain and the green tuff, no rice is infected with glume blight, and therefore, a microbial protective rate of 100 percent was achieved.

In contrast, in another segment where coating agent 2, which is the freeze-dry powder consisting essentially of the Herbaspirillum sp. 022S4-11 strain without the presence of the green tuff, the suppressive effect of a certain degree was achieved. However, compared to coating agent 1 with the presence of the green tuff powder, the microbial protective rate significantly decreased and far inferior.

As results, it was found that the coating agents prepared by the freeze drying process of an aqueous suspension of the rock powder and the beneficial microorganisms significantly increases the suppressive effects against glume blight of rice.

TABLE 1

| | treatment conditions | | | number of | number of seedling | | | disease | disease | suppresive |
|---|---|---|---|---|---|---|---|---|---|---|
| Segment | timing | temp | period | seedling | index 0 | index 3 | index 5 | rate | severity | effect |
| coating agent 1 | seed immersed | 25 C. | 48 hrs. immersed | 233 | 233 | 0 | 0 | 0.0 | 0.0 | 100 |
| coating agent 2 | seed immersed | 25 C. | 48 hrs. immersed | 249 | 166 | 56 | 27 | 39.1 | 28.6 | 68.9 |
| no coating agent | seed immersed | 25 C. | 48 hrs. immersed | 145 | 0 | 26 | 119 | 100.0 | 92.0 | — |

### (7) Research of Freeze-Dried Microbial Control Agent in Living Bacteria Number

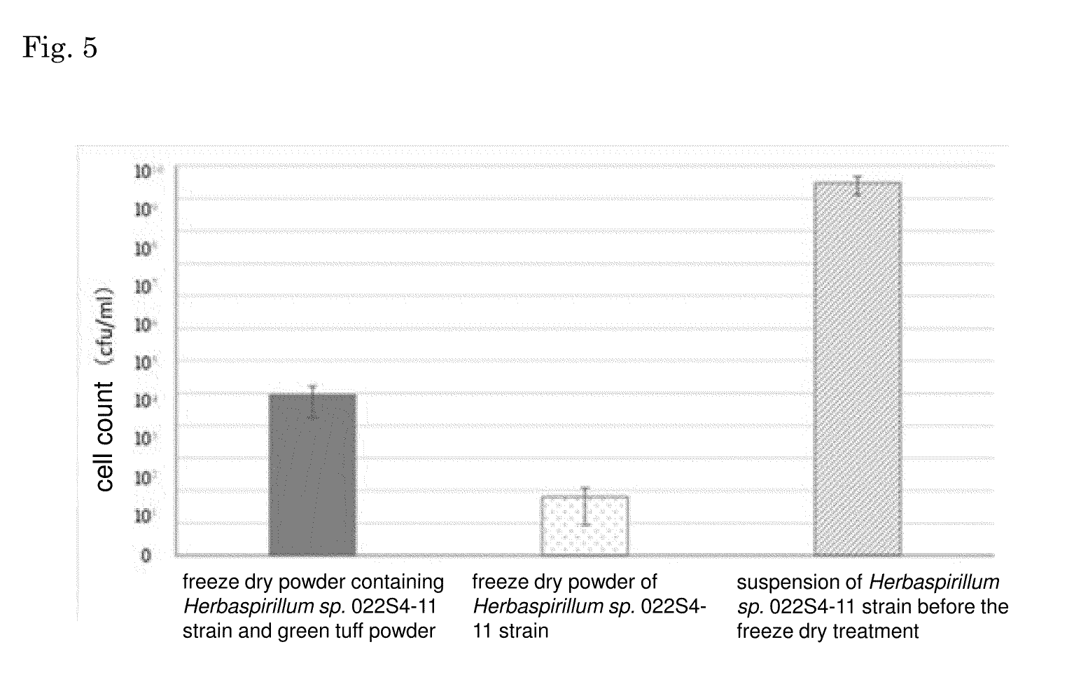

A liquid suspension of Herbaspirillum sp. 022S4-11 strain (about 10⁹ cfu/ml) was mixed with an aqueous liquid containing approximately 30 percent by weight of the Towada stone, which is the green tuff powder. The mixture was frozen and then freeze dried to prepare a powder mixture containing the bacteria and green tuff. With regard to this suspension, a number of surviving bacteria in the powder mixture was counted by a dilution plate method using a standard agar medium. For comparison, a bacterial suspension without the green tuff powder was freeze dried in the same conditions, and the number of surviving bacteria was counted in the same manners. The results are shown in FIG. 5. The cell count in the freeze dried mixture containing bacteria and green tuff powder was approximately 10⁴ cfu/ml. It is found that the cell count is much larger than that of the freeze dried green tuff powder that does not contain the green tuff, which is under the 10² cfu/ml, and that the cell count is significantly decreased compared to that before the freeze drying process. In view of this results and results in Table 1, we can conclude that microbial control with significantly decreased count by freeze drying living bacteria is peculiarly effective in the co-existence with the green tuff powder Herbaspirillum sp. 022S4-11 strain.

1. A microbe-protective agent comprising a protective agent in a powder form for suppressing the death of beneficial microorganism to give effective control over plant diseases, wherein the powder is consisting essentially of a rock powder.

2. A microbe-protective agent of claim 1 wherein the rock powder has an average particle diameter of 1 to 400 micrometers.

3. A microbe-protective agent of claim 1 wherein said rock consists essentially of tuff or granite.

4. A microbe-protective agent of claim 1 wherein said rock consists essentially of green tuff or pumice tuff.

5. A microbe-protective agent of claim 1 wherein said rock consists essentially of at least one species selected from Towada-stone, Oya-stone, and mica.

6. A processing agent of plant protection against diseases, comprising
a beneficial microorganism; and
a microbe-protective agent consisting essentially of a rock powder for preventing the death of the bacteria cell.

7. A processing agent of plant protection against diseases of claim 6 wherein the rock powder has an average particle diameter of 1 to 400 micrometers.

8. A processing agent of plant protection against diseases of claim 7 wherein the rock consists essentially of tuff or granite.

9. A processing agent of plant protection against diseases of claim 6 wherein the rock consists essentially at least one of the species selected from Towada-stone, Oya-stone, and mica.

10. A processing agent of plant protection against diseases of claim 6 wherein the beneficial microorganism is bacteria cell in the genus Herbaspirillum.

11. A processing agent of plant protection against diseases of claim 6, prepared by a process comprising the step of freeze-drying a composition comprising the microbe-protective agent and a beneficial microorganism.

12. A coated seed comprising a plant seed coated by a processing agent of plant protection against diseases of claim 6.

13. A coated seed of claim 12 wherein the plant belongs to the family Poaceae.

14. A coated seed of claim 12 wherein the beneficial microorganism is a bacteria cell in the genus Herbaspirillum.

15. A method of preparing a coated seed comprising the step of:
immersing a plant seed into an aqueous suspension comprising
a beneficial microorganism; and
a microbe-protective agent consisting essentially of a rock powder for suppressing the death of the beneficial microorganism.

16. A method of preparing a coated seed of claim 15 further comprising the step of decompressing the aqueous suspension while the seed is immersing in the aqueous solution.

17. A method of preparing a coated seed of claim 15 wherein a concentration of the beneficial microorganism in the aqueous suspension ranges from 10˜10¹² cfu/mL.

18. A method of preparing a coated seed of claim 15 wherein the beneficial microorganism is a bacteria cell in the genus Herbaspirillum.

19. A method of preparing a coated seed of claim 15 wherein the aqueous suspension is prepared by the steps of:
freeze-drying a liquid containing the microbe-protective agent and the beneficial microorganism to obtain a freeze-dry mixture; and
preparing an aqueous suspension by suspending the freeze-dried mixture in an aqueous liquid.

20. A method of preparing a coated seed of claim 18 wherein the beneficial microorganism is a bacteria cell in the genus Herbaspirillum.
